(19) United States
(12) Patent Application Publication
(10) Pub. No.: US 2011/0213932 A1
(43) Pub. Date: Sep. 1, 2011

(54) DECODING APPARATUS AND DECODING METHOD

(76) Inventors: Takuma CHIBA, Osaka (JP); Tatsuro Juri, Osaka (JP)

(21) Appl. No.: 13/032,153

(22) Filed: Feb. 22, 2011

(30) Foreign Application Priority Data
Feb. 22, 2010 (JP) 2010-036507

(51) Int. Cl. G06F 12/08

(52) U.S. Cl. 711/125; 711/E12.02

(57) ABSTRACT

A decoding apparatus is used which includes: a CABAC processing unit (22) which generates a coding condition (23a) when performing arithmetic decoding; a first storage medium which stores arithmetic-decoded data (24d); a cache 25 which is a second storage medium which stores cache data (25d); a decoder (26) which processes the arithmetic-decoded data (24d), based on the cache data (25d); and a setting unit (23) which sets a storage method for the cache data (25d) based on the coding condition (23a), prior to the processing.

### BACKGROUND OF THE INVENTION

(1) Field of the Invention

The present invention relates to a moving picture decoding apparatus and method.

(2) Description of the Related Art

At present, with the advancement in picture data digitalization, picture coding is now being performed on video data which requires a large data amount, so as to reduce such data amount, and the coded video data is recorded and transmitted.

Here, efficient picture compression coding standards such as MPEG-2 (MPEG: Moving Picture Experts Group) and MPEG-4 AVC/H.264 (hereafter abbreviated as H.264; AVC: Advanced Video Coding) are used as picture coding standards. In these standards, coding is performed on a rectangular unit (normally composed of 16 pixels horizontally and 16 pixels vertically) basis called a macroblock. Furthermore, during the coding of a macroblock, in order to enhance compression efficiency, an image similar to the image of such macroblock is searched out and retrieved from another field or frame that has been coded ahead. Subsequently, the difference value between the pixel value of the retrieved image and the pixel value of the macroblock is coded. Here, such a process is called motion compensation. In addition, at the time of picture coding, the position of the retrieved pixel value is concurrently coded as a motion vector.

Next, an example of a picture decoding apparatus which decodes data that was coded using motion compensation shall be described using FIG. 6.

FIG. 6 is diagram showing a conventional picture decoding apparatus 600.

In FIG. 6, 601 is a coded data input unit, 603 is a variable-length decoding unit, 604 is a pixel value decoding unit, 605 is a motion vector extraction unit, 606 is a motion compensation unit, 607 is a picture output unit, and 608 is a memory.

Picture-coded data that is inputted from the coded data input unit 601 in FIG. 6 is variable-length decoded by the variable-length decoder 603 on a macroblock basis. The motion vector extraction unit 605 extracts, from the variable-length-decoded data, motion vector information for the macroblock (motion vector information to be used in decoding such macroblock). Subsequently, using this motion vector information, the motion compensation unit 606 reads the pixel value required for motion compensation from among pixel values that have already been decoded (in the past) and are stored in the memory 608, and generates a motion compensation pixel.

Meanwhile, the pixel value decoding unit 604 generates motion compensation difference data for the macroblock, using the data decoded by the variable-length decoder 603. In addition, the pixel value decoding unit 604 decodes pixel data by adding the generated motion compensation difference data and a motion compensation value which is generated from the read (past) pixel value (described above) and obtained from the motion compensation unit 606. The decoded pixel data is first stored in the memory 608 then outputted from the pixel output unit 607 in accordance with the reproduction timing of a TV or the like. Furthermore, the decoded pixel data stored in the memory 608 is also used in the motion compensation of other macroblocks.

Now, the configuration in FIG. 6 allows picture-coded data to be decoded to video data. In addition, in the above-described motion compensation, for each macroblock or for each fractional-unit thereof, it is possible to refer to a pixel at an arbitrary position, which has already been decoded in the past. As such, in order to execute motion compensation, it becomes necessary to read the value of a pixel at a random position, from the memory 608, for each macroblock.

Generally, since picture-decoded picture data has an extremely large data amount, the aforementioned memory 608 is configured of an external Dynamic Random Access Memory (DRAM). Meanwhile, with a DRAM, large overhead arises and high-speed reading is difficult when reading is performed arbitrarily in small rectangular units such as the macroblock. As such, in order to decode high-speed, large-volume pictures, such as in high-definition pictures, it becomes necessary to use a number of expensive high-speed DRAMS in parallel, thus entailing significant circuit cost and power consumption.

As an example for solving such a problem, conventional picture decoding apparatuses are disclosed in Patent Reference 1 (Japanese Unexamined Patent Application Publication No. 2005-102144) and Patent Reference 2 (Japanese Unexamined Patent Application Publication No. 2006-31480). The example techniques disclosed in these Patent References are techniques of reducing memory access to an external DRAM during the decoding of H.264-coded data.

FIG. 7 is diagram showing a conventional picture decoding apparatus 700.

An example of the picture decoding apparatuses described in Patent Reference 1 and Patent Reference 2 shall be described using FIG. 7. The picture decoding apparatus 700 shown in FIG. 7 includes, further to the picture decoding apparatus 600 shown in FIG. 6, a reference picture cache 702. Among the components included in the picture decoding apparatus 700 shown in FIG. 7, components having the same function as components included in the picture decoding apparatus 600 shown in FIG. 6 are given the same reference numerals and detailed description shall not be repeated.

A motion vector extraction unit 705 extracts motion vector information for the macroblock, out of the data that was variable-length-decoded by the variable-length decoder 603. Then, using this motion vector information, the reference picture cache 702 is accessed for the reading of a pixel required for motion compensation. Upon receiving the read access, the reference picture cache 702 forwards the required pixel to a motion compensation unit 706 when such pixel is present inside the reference picture cache 702. On the other hand, when the required pixel is not present, the motion compensation unit 706 judges that a cache miss has occurred and performs a read access to the memory 608. Upon receiving the picture read access, the memory 608 obtains the pixel data requested in the read access, and transmits such pixel data to the motion compensation unit 706. Furthermore, at this time, the aforementioned pixel data that is transmitted to the motion compensation unit 706 is also forwarded to the reference picture cache 702 and stored inside the reference picture cache 702.

The motion compensation unit 706 generates a motion compensation pixel using the pixel value of the reference picture inputted to the motion compensation unit 706 from the reference picture cache 702 or the memory 608. Subsequently, the generated motion compensation pixel is outputted to the pixel value decoding unit 604.

It should be noted that, since the video data decoding process from the pixel value decoding unit 604 onward is the same as in the picture decoding apparatus 600 shown in FIG. 6, detailed description shall not be repeated.

As described above, when the reference picture cache 702 is provided in a picture decoding apparatus, the following can be said about the pixel value of a reference picture required in performing motion compensation. Specifically, when the required pixel value is stored inside the reference picture cache 702, the need to access the memory 608 is eliminated, thus allowing the access amount to the memory 608 to be reduced.
Patent Reference 1: Japanese Unexamined Patent Application Publication No. 2005-102144
Patent Reference 2: Japanese Unexamined Patent Application Publication No. 2006-31480

### SUMMARY OF THE INVENTION

As shown in the above-described prior art, in the techniques disclosed in Patent Reference 1 and Patent Reference 2, reference picture data that is read from an external memory (memory 608) in order to perform motion compensation on a macroblock is stored in the reference picture cache 702. Then, when the required reference picture at the time when subsequent macroblock motion compensation is performed is the picture of the aforementioned reference pixel data stored in the reference picture cache 702, such stored reference picture data of the reference pixel is read from the reference picture cache 702. With this, access to the external memory (memory 608) is reduced.

Meanwhile, the configuration of a cache is generally as shown in FIG. 8 and FIG. 9.

FIG. 8 is a block diagram showing a direct-mapped cache (cache 800).

The direct-mapped cache 800 includes a cache memory array 804 and a comparator 807, and is a data reading system having a memory address 801 as an input. The memory address 801 is composed of a tag part 802 and an index part 803, and reads data from the cache memory array 804, using the index part 803 as an address of the cache memory array 804. Plural pairs of a cache tag 805 and data 806 are stored in the cache memory array 804. In addition, when a read access to the cache memory array 804 is performed, the cache memory array 804 outputs the cache tag 805 and the data 806 one pair at a time. The comparator 807 compares the cache tag 805 read from the cache memory array 804 and the tag part 802. When they match, the comparator 807 outputs a signal indicating a cache hit together with the data 806 (data 8061), as a cache hit. When they do not match, the comparator 807 outputs a signal indicating a cache miss.

FIG. 9 is a block diagram showing a set-associative cache (cache 900), and, in particular, is an example of the case where the number of ways is 2.

The set-associative cache 900 includes a cache memory array 904, a way 0 comparator 909, a way 1 comparator 910, a logical OR (logical OR operation unit) 911, and a data selection unit 912. This system is a data reading system having the memory address 801 as an input. It should be noted that since the memory address 801 has the same configuration as the memory address 801 in FIG. 8, the same numerical reference has been given and detailed description shall not be repeated.

Plural sets of a way 0 cache tag 905, a way 1 cache tag 906, way 0 data 907, and way 1 data 908 are stored in the cache memory array 904. When a read access is performed with the index part 803 as input, the cache memory array 904 outputs the way 0 cache tag 905, the way 1 cache tag 906, the way 0 data 907, and the way 1 data 908 one set at a time. The way 0 comparator 909 compares the read way 0 cache tag 905 to the tag part 802 of the memory address 801. When they match, the way 0 comparator 909 makes valid a way 0 hit signal. Furthermore, the way 1 comparator 910 compares the way 1 cache tag 906 to the tag part 802. When they match, the way 1 comparator 910 makes valid a way 1 hit signal.

The logical OR 911 obtains the logical OR of the way 0 hit signal and the way 1 hit signal, and a cache hit (a signal 9111 indicating a cache hit or otherwise) is outputted by the logical OR 911.

When both the way 0 hit signal and the way 1 hit signal are not valid, the logical OR 911 outputs a cache miss.

The way 0 hit signal and the way 1 hit signal, and the way 0 data 907 and way 1 data 908 read from the cache memory array 904 are inputted to the data selection unit 912.

Then, the data selection unit 912 selects the way 0 data when the way 0 hit signal is valid, and selects the way 1 data when the way 1 hit signal is valid, and the selected data (data 912I) is outputted by the data selection unit 912 as output data.

As described above, cache configurations include various schemes such as the direct mapping scheme and the set-associative scheme. In addition, various configurations can also be adopted in terms of the number of entries which is the number of pairs of tags and data to be stored in the cache array, or the number of ways in the set-associative scheme. Furthermore, in general, when creating a system using a cache, the most appropriate cache configuration for such system is usually uniquely determined and installed. This is because, in terms of cache characteristics, it is necessary to clear the contents of a cache when changing the configuration of the cache (the storage method of the stored cache data), and it is not possible to actively change the cache configuration during system operation.

Meanwhile, even for a cache provided in a picture decoding apparatus, the configuration is also uniquely determined and installed as described above.

However, for performing picture decoding, it is preferable that, for each picture to be decoded, the cache configuration is changed to a configuration that is appropriate for such picture. However, none of the past picture decoding apparatuses included a mechanism for changing between these configurations.

This is due to the reason that the cache configuration that is most appropriate for a picture to be decoded does not become clear until the decoding of the picture is performed. More specifically, depending on the picture to be decoded, there are instances where the uniquely determined configuration is inappropriate for that picture, and thus decoding is performed using an inappropriate configuration.

The present invention has as an object to change cache configurations in a decoding apparatus provided with a cache, so as to perform decoding using a cache having a configuration that is appropriate for the picture to be decoded and to reduce the access amount of accesses to an external memory arising due to a cache miss.

It should be noted that another object of the present invention includes providing a decoding apparatus capable of maintaining, at a relatively small number of stages (such as two stages shown in FIG. 1, FIG. 10, and so on), the number of stages of processes performed despite the generation of information (see coding condition 23a in FIG. 10) used for the above-described reduction.

It should be noted that at least part of the other objective of the present invention includes a decoding apparatus (see decoding apparatus 100 and so on in FIG. 10 and so on) capable of relatively appropriate operation during the performance of decoding in the H.264 high profile.

In order to solve the aforementioned problem, the present decoding apparatus is a decoding apparatus that decodes coded data generated through coding including at least arithmetic coding, the decoding apparatus including: an obtainment unit configured to obtain the coded data; a first decoding unit configured to perform arithmetic decoding on the obtained coded data to generate (i) a coding condition of the coded data and (ii) arithmetic-decoded data; a first storage medium for storing the coding condition and the arithmetic-decoded data, the first storage medium having a first capacity and allowing reading of stored information at a first speed; a second storage medium for storing cache data, the second storage medium having a second capacity which is smaller than the first capacity and allowing reading of stored information at a second speed which is faster than the first speed, and the cache data being picture data that is part of decoded picture data stored in the first storage medium; a second decoding unit configured to decode the arithmetic-decoded data based on the decoded picture data stored in the first storage medium or the cache data stored in the second storage medium; and a storage method setting unit configured to set a storage method for storing the cache data in the second storage medium, based on a coding condition obtained during generation of coded data which precedes current coded data to be decoded by the second decoding unit.

In addition, for example, the method for storing the cache data (cache data when the second coded data is to be decoded) in the second storage medium, based on the coding condition obtained during the generation of the coded data (second coded data that is different from the first coded data) preceding the current coded data to be decoded (for example, the first coded data which is to be decoded at a first time) by the second decoding unit.

It should be noted that, for example, prior to the decoding (for example, the decoding of the second coded data) by the second decoding unit, the method for storing the cache data (cache data when the second coded data is to be decoded) in the second storage medium may be set based on the coding condition generated in the arithmetic decoding of the coded data (second coded data) which is to be decoded by the second decoding unit.

Specifically, for example, prior to the decoding (for example, the decoding of the second coded data) by the second decoding unit, the storage method in that decoding process may be set, and the aforementioned coding condition (coding condition for the second coded data) may be generated in the arithmetic decoding process (arithmetic decoding process by which the second coded data is generated) performed even before such setting.

Specifically, this decoding apparatus may be, for example, a decoding apparatus which includes: an arithmetic decoding unit which performs arithmetic decoding on a coded stream that was coded using arithmetic coding, to generate arithmetic-decoded data; a binary data decoding unit which performs binary data-decoding on the generated arithmetic-decoded data to generate coefficient data, reference picture information, and picture mufti-value data; a storage unit which stores reference pictures made up of pixel values coded in the past; a motion compensation unit which generates a motion compensation signal, using pixel data of the reference picture stored in the storage unit and motion vector information; a pixel value decoding unit which generates a decoded pixel value, based on the coefficient data and the motion compensation signal; a reference pixel data cache which stores the pixel data of the reference picture used by the motion compensation unit; a reference picture information obtainment unit which obtains, based on the arithmetic-decoded data, reference picture information regarding the reference picture used by the motion compensation unit and the pixel value of the reference picture; and a creation unit which creates the configuration of the reference pixel data cache, based on the obtained reference picture information.

It should be noted that the creation unit may specifically, for example, output, to the other processing units such as the reference pixel data cache, cache configuration information (number of ways, and so on) for specifying the configuration to be set for the reference pixel data cache. In addition, the configuration of the reference pixel data cache may be changed by the other processing units, into the configuration specified in the outputted cache configuration information. In this manner, the creation unit may create the configuration by outputting cache configuration information and causing the other processing units to which the information is outputted, to perform the changing process.

It should be noted that, for example, as described in detail in the embodiment, the reference pixel data cache may store respective parts of the data to be stored, in sub-regions corresponding to that part in one or more sub-regions obtained by dividing the storage region of the reference pixel data cache. In addition, creating the configuration of the reference pixel data cache may specifically be, for example, specifying the number of sub-regions and causing storage according to the specified number of sub-regions.

It should be noted that a coding apparatus which codes inputted moving pictures by inter picture prediction may include: a picture coding unit which codes the inputted moving pictures to output coded data and a reference picture to be used at the time of inter-picture prediction; a storage unit which stores the reference picture; a storage control unit which controls storage and release of the reference picture, for each of management regions that is smaller than an entire region of the reference picture; and a region motion vector calculation unit which divides, into partial regions, one current picture to be coded included in the moving pictures, and calculates a partial region motion vector for each of the partial regions, wherein the storage control unit may, based on the partial region motion vectors, release a management region that is determined not to be used when coding the current picture to be coded, among the management regions, and perform coding. Furthermore, the storage control unit may, based on the partial region motion vectors, count the number of usages for each management region used in the coding of a moving picture signal, determine a management region that will not be used in the coding of the moving picture signal based on the count result, release the management region, and perform coding. Such a coding apparatus may be combined with the above-described decoding apparatus.

The present invention produces the advantageous effect of allowing the reduction of memory accesses arising from the reading of a pixel value of a reference picture from the memory when performing motion compensation in a picture decoding apparatus which decodes a coded stream obtained by coding video using arithmetic coding and inter-picture prediction coding, to generate the video.

By extension, for example, the power consumed in the memory accesses is reduced, thus allowing power consumption to be reduced.

The number of processing stages (the number of passes of processing to be performed) can be maintained at a relatively small number of stages (for example, the two stages shown in FIG. 1, FIG. 10, and so on).

With this, having minimal power consumption and a minimal number of stages can both be achieved.

It is possible to provide a decoding apparatus (decoding apparatus 100 in FIG. 1, FIG. 10, and so on) capable of relatively appropriate operation during the performance of decoding in the H.264 high profile.

Necessary information (coding condition) is generated in a relatively fast time and appropriate processing is performed from an early time, and thus, for example, power consumption can be reduced relatively significantly.

### FURTHER INFORMATION ABOUT TECHNICAL BACKGROUND TO THIS APPLICATION

The disclosure of Japanese Patent Application No. 2010-036507 filed on Feb. 22, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a configuration of a decoding apparatus in an embodiment;

FIG. 2 is a diagram showing a flow of operations performed by the decoding apparatus in the embodiment;

FIG. 3 is a flowchart showing a relationship between a picture to be decoded and reference pictures, in a fourth method of determining a reference picture cache configuration;

FIG. 4 is a diagram showing a configuration of a reference picture cache configuration determination unit in a fifth method of determining a reference picture cache configuration;

FIG. 5 is a flowchart showing the flow of operations performed by the reference picture cache configuration determination unit, in the fifth method of determining the reference picture cache configuration;

FIG. 6 is a diagram showing an example of a picture decoding apparatus which decodes data coded using motion compensation;

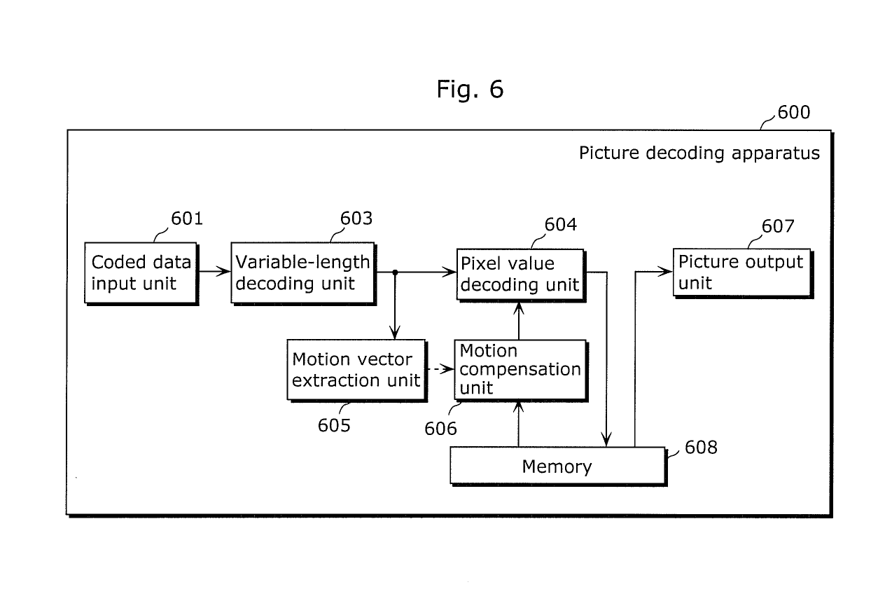

FIG. 7 is a diagram showing an example of a picture decoding apparatus which decodes data coded using motion compensation, and includes a reference picture cache;

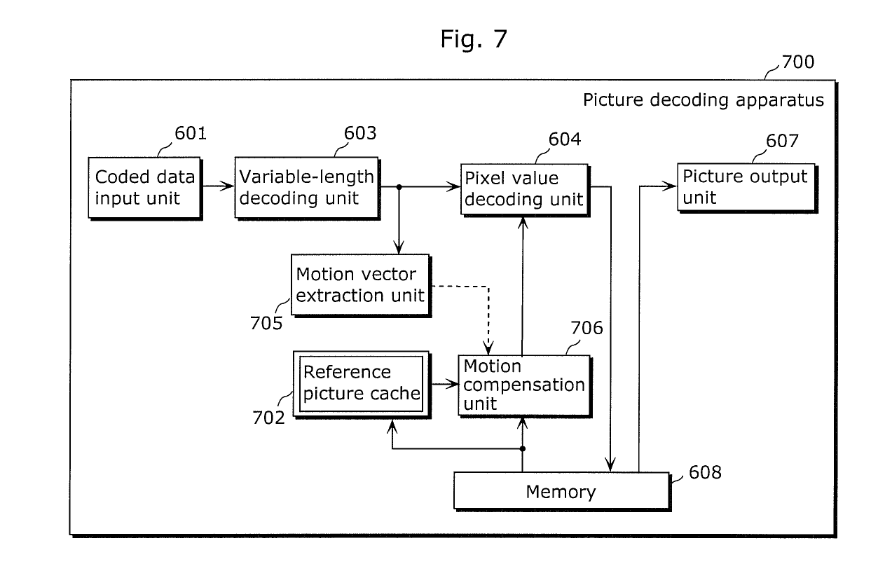

FIG. 8 is a diagram showing an example of a direct-mapped cache;

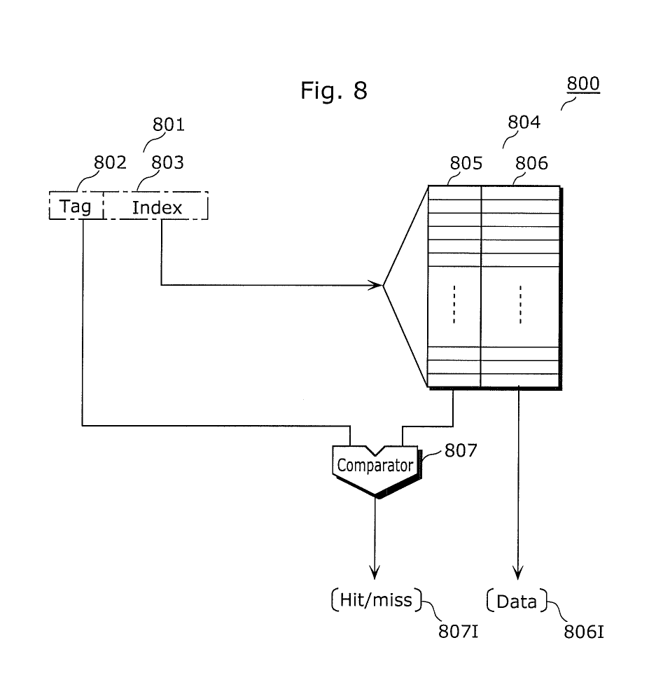

FIG. 9 is a diagram showing an example of a set-associative cache;

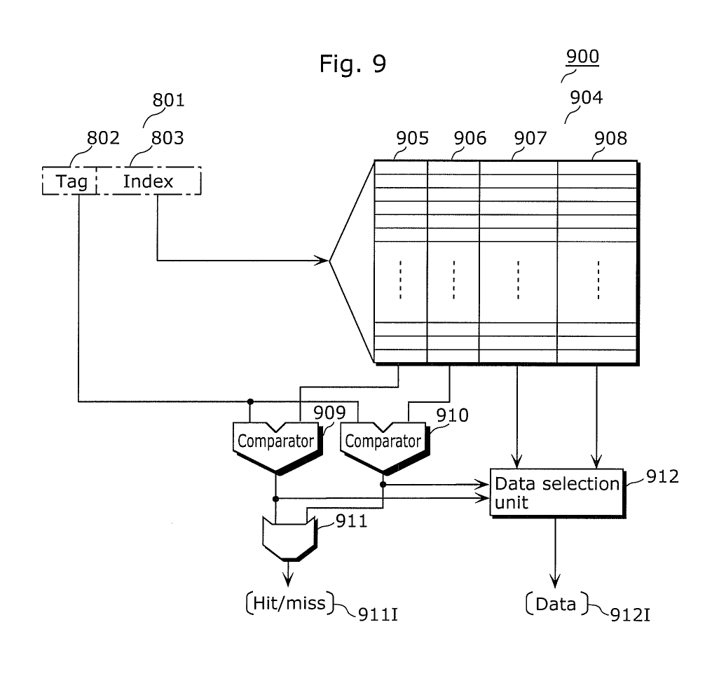

FIG. 10 is a diagram showing a configuration of a decoding apparatus;

FIG. 11 is a diagram showing cache data to be stored, and so on;

FIG. 12 is a diagram showing cache data to be stored, and so on;

FIG. 13 is a diagram showing data about correspondence relationships, and so on;

FIG. 14 is a diagram showing plural addresses, and so on;

### DESCRIPTION OF THE PREFERRED EMBODIMENT

Hereinafter, an embodiment of the present invention shall be described with reference to the Drawings.

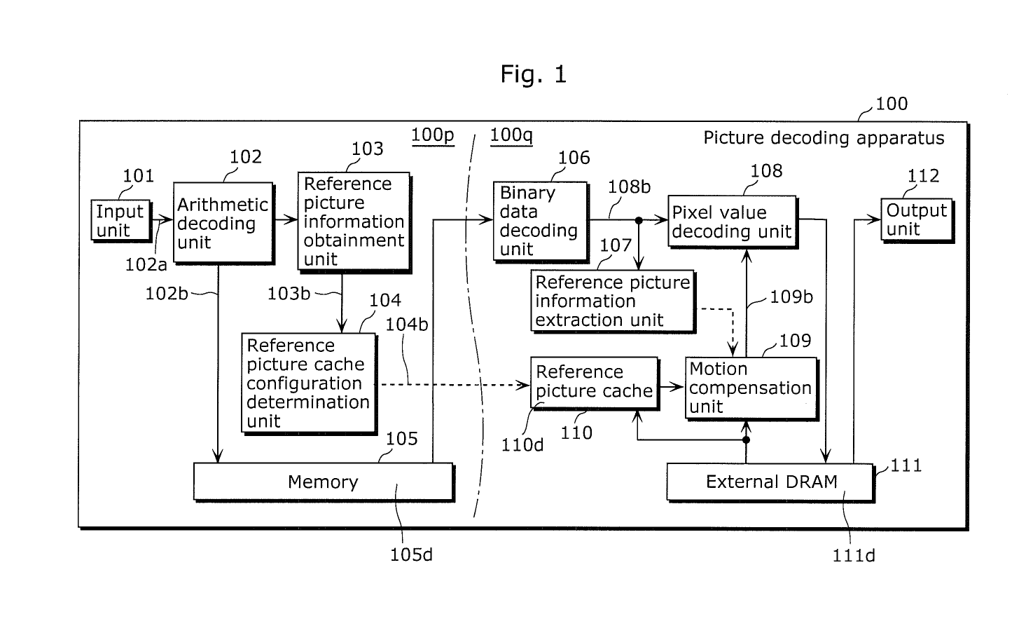

The decoding apparatus in the embodiment is a decoding apparatus 100 that decodes coded data (coded data 21b in FIG. 1) generated through coding including at least arithmetic coding, the decoding apparatus (picture decoding apparatus) 100 including: an input unit 21 which obtains the coded data 21b; a CABAC processing unit 22 which performs arithmetic decoding on the obtained coded data 21b to generate (i) a coding condition 23a of the coded data 21b and (ii) arithmetic-decoded data 24d; a first storage medium (DRAM) 24 for storing the coding condition 23a and the arithmetic-decoded data 24d, the first storage medium 24 having a first capacity and allowing reading of stored information at a first speed; a second storage medium (cache) 25 for storing cache data 25d, the second storage medium having a second capacity which is smaller than the first capacity of the first storage medium 24 and allowing reading of stored information at a second speed which is faster than the first speed of the first storage medium 24, and the cache data 25d partial picture data 24eP that is part of decoded picture data 24e stored in the first storage medium 24; a second decoding unit (decoder) 26 which decodes the arithmetic-decoded data 24d based on the decoded picture data 24e stored in the first storage medium 24 or the cache data 25d stored in the second storage medium; and a setting unit (storage method setting unit) 23 which sets a storage method for storing the cache data 25d in the second storage medium 25, based on a coding condition (coding condition 23a, and so on) obtained during generation of coded data (which precedes current coded data (first coded data) to be decoded by the second decoding unit 26).

Specifically, for example, the method for storing the cache data 25d in the second storage medium when the coded data (second coded data) is to be decoded by the second decoding unit 26 may be set based on the coding condition 23a obtained when the CABAC processing unit 22 generates coded data (see second coded data to be decoded by the second decoding unit in a second time: coded data 24d).

It should be noted that, for example, the second coded data is coded data, and so on, (different from the first coded data) that precedes the current coded data to decoded by the second decoding unit 26 (the first coded data which is to be decoded at a first time that is different from the aforementioned second time).

Specifically, in the decoding apparatus 100, for example, the decoder 26 may decode the arithmetic-decoded data 24d (the second coded data, and so on) based on the decoded picture data 24e to be stored in the first storage medium 24 or the cache data 25d to be stored in the second storage medium 25, and the method for storing the cache data 25d (cache data of the second coded data) in to the second storage medium 24 may be set based on coding condition 23a generated in the arithmetic decoding of the coded data (second coded data) to be decoded by the second decoding unit 26, prior to the decoding of coded data (first coded data) by the second decoding unit 26.

Furthermore, for example, with this, the storage of the cache data 25d is performed according to the appropriate storage method that has been set, and thus cache misses can be reduced. Accordingly, by extension, accesses to the second storage medium 25 are reduced, and thus the power consumed in accesses is reduced, and thus power consumption can be reduced.

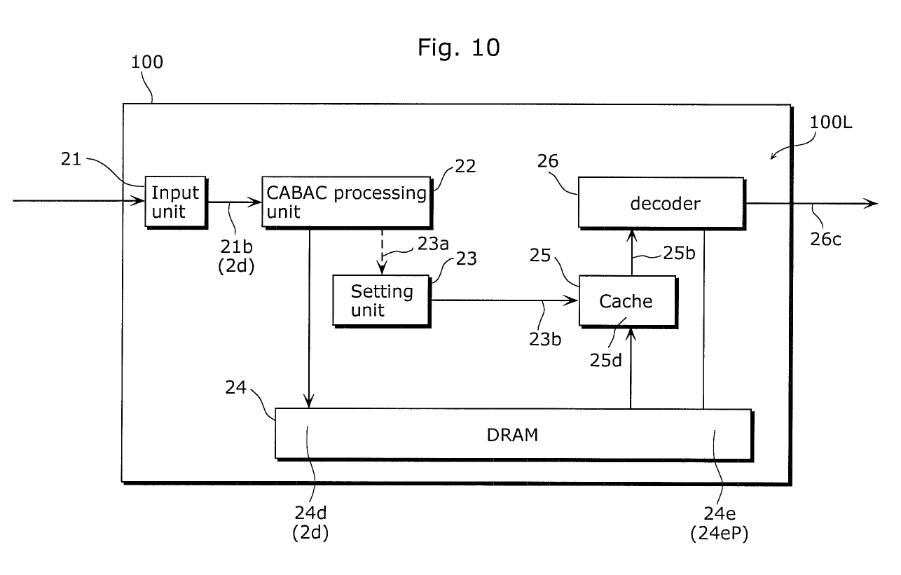

In addition, the number of process stages (number of passes of processing to be performed) in the decoding apparatus 100 can be maintained at a small number of stages (for example, the two stages shown in FIG. 1 and FIG. 10).

With this, having minimal power consumption and a minimal number of stages can both be achieved.

It should be noted that reducing the number of stages in the manner described above allows, by extension, for example, processing to be relatively simplified, and thus allow power consumption to be more significantly reduced.

It should be noted that, as described above, the first stage processing is the arithmetic decoding process.

Specifically, for example, the present decoding apparatus is a decoding apparatus that performs decoding in the H.264 high profile. With this, it is possible to provide a decoding apparatus capable of relatively appropriate operation during the performance of decoding in the H.264 high profile.

This decoding apparatus may be, for example, a decoding apparatus (picture decoding apparatus) which includes: an arithmetic decoding unit (arithmetic decoding unit 102) which performs arithmetic decoding on a coded stream that was coded using arithmetic coding, to generate arithmetic-decoded data; a binary data decoding unit (binary data decoding unit 106) which performs binary data-decoding on the generated arithmetic-decoded data to generate coefficient data, reference picture information, and picture mufti-value data; a storage unit (external DRAM 111) which stores reference pictures made up of pixel values coded in the past; a motion compensation unit (motion compensation unit 109) which generates a motion compensation signal, using pixel data of the reference picture stored in the storage unit and motion vector information; a pixel value decoding unit (pixel value decoding unit 108) which generates a decoded pixel value, based on the coefficient data and the motion compensation signal; a reference pixel data cache (reference picture cache 110) which stores the pixel data of the reference picture used by the motion compensation unit; a reference picture information obtainment unit (reference picture information obtainment unit 103) which obtains, based on the arithmetic-decoded data, reference picture information regarding the reference picture used by the motion compensation unit and the pixel value of the reference picture; and a creation unit (reference picture cache configuration determination unit 104) which creates the configuration of the reference pixel data cache, based on the obtained reference picture information.

It should be noted that the reference picture information regarding the reference picture used by the motion compensation unit and the pixel value of the reference picture may specifically specify, for example, the reference picture used by the motion compensation unit from plural pictures, and specify the pixel value of the specified reference picture.

Furthermore, specifically, through the creation of the configuration, for example, in creating the configuration, the reference pixel data cache may be caused to perform, out of plural processes, a process which corresponds to the configuration to be created. Here, for each of the respective processes, for example, the number of reference pictures to be used by the motion compensation unit which is appropriate for performing the process may be different from the appropriate number for the other processes.

It should be noted that the setting unit may set the method for storing the cache data (cache data when the first coded data is to be decoded) in the second storage medium 25, based on the coding condition (coding condition for the second coded data) obtained during the generation of the coded data (second coded data that is different from the first coded data) preceding the current coded data to be decoded (first coded data) by the second decoding unit 26.

In this manner, information (coding condition) required for the setting of the storage method is generated during the arithmetic decoding by the CABAC processing unit 22. As such, there is no need to increase the number of stages by performing processes other than those in the first stage (CABAC processing unit 22) and second stage (decoder 26), and thus a small number of stages (for example, two) can be maintained. In addition, appropriate processing using the coding condition is generated in the first processing stage, generated in a relatively early time, and performed from an early time, and thus allowing sufficiently appropriate processing.

Detailed description follows.

FIG. 1 is a diagram showing an example of a decoding apparatus shown in the present embodiment.

A picture decoding apparatus (decoding apparatus) is an apparatus which decodes a coded stream coded using arithmetic coding, and outputs picture data resulting from the decoding of the coded stream.

In addition, the picture decoding apparatus includes an input unit 101, the arithmetic decoding unit 102, the reference picture information obtainment unit 103, the reference picture cache configuration determination unit 104, a memory 105, the binary data decoding unit 106, a reference picture information extraction unit 107, the pixel value decoding unit 108, the motion compensation unit 109, the reference picture cache 110, the external DRAM 111, and an output unit 112.

A coded stream is inputted to the picture decoding apparatus via the input unit 101. The inputted coded stream is arithmetic-decoded by the arithmetic decoding unit 102 so as to generate arithmetic-decoded data resulting from the arithmetic-decoding of the coded stream. The generated arithmetic-decoded data is first stored in the memory 105.

Here, in the case of H.264 coding, the arithmetic-decoded data is also called binarization data. Normally, significant unevenness in processing time occurs in the arithmetic decoding process. As such, the arithmetic decoding process cannot be performed in synchronization with the pixel value decoding process in which processing is performed on a macroblock basis. As such, for the arithmetic-decoded data after the decoding process has been performed, data for a sufficient number of macroblocks is first stored in a memory (the memory 105 in FIG. 1), after which the stored data is read and processed in synchronization with the decoding process on the macroblock basis.

Next, along with being stored in the memory 105, the arithmetic-decoded data is inputted to the reference picture information obtainment unit 103, and reference picture information is obtained from the inputted arithmetic-decoded data. Here, reference picture data is information regarding a reference picture and a pixel value of the reference picture, which is to be used subsequently by the motion compensation unit 109.

The reference picture cache configuration determination unit 104 has this reference picture information as input, and outputs cache configuration information for determining the configuration of the reference picture cache 110.

It should be noted that, here, when H.264 coding is used, the decoding of pixel data is often performed on a per picture basis or in slices which are obtained by dividing a picture. In view of this, the configuration of the reference picture cache 110, which is determined by the outputting of the cache configuration information by the reference picture cache configuration determination unit 104, is determined on a per picture basis or a per slice basis. In other words, the reference picture cache configuration determination unit 104 outputs the cache configuration information on a per picture basis or a per slice basis.

The cache configuration information is forwarded to the reference picture cache 110 and sets the reference picture cache 110 when pixel data of the picture corresponding to the cache configuration information is decoded.

More specifically, through the forwarding of the cache configuration information, the reference picture cache 110 performs, during the decoding of the picture corresponding to the forwarded cache configuration information, the processing according to the configuration in the cache configuration information.

Next, the previously described arithmetic-decoded data stored in the memory 105 is read on a macroblock basis by the binary data decoding unit 106, and the binary data decoding unit 106 performs the decoding to generate coefficient data, reference picture information, and picture mufti-value data.

Here, the reference picture information extraction unit 107 performs, on the decoded data, a process for detecting a motion vector and reference picture index number (refIdx) that correspond to a macroblock thereof. Then, using the detected motion vector and so on, a reference pixel (a copy reference pixel of the reference pixel stored in the external DRAM 111) to be used in motion compensation is read from the reference picture cache 110.

Here, there are cases where the reference pixel (copy) to be used in motion compensation is not stored in the reference picture cache 110. It should be noted that these cases are cases where what is called a cache miss occurs. In this case, the reference pixel to be used in motion compensation is read from the external DRAM 111. At the same time, the reference pixel read from the external DRAM 111 is stored in the reference picture cache 110.

The motion compensation unit 109 generates an interpolated pixel (see data 109b in FIG. 1) to be used in motion compensation, from the reference pixel that is read from the reference picture cache 110 or the external DRAM 111.

The pixel value decoding unit 108 performs inverse quantization and inverse orthogonal transform on the coefficient data decoded by the binary data decoding unit 106, and converts the decoded coefficient data into a difference pixel value. Subsequently, the pixel value decoding unit 108 adds the difference pixel value obtained from the conversion and the interpolated pixel for motion compensation generated by the motion compensation unit 109, decodes the resulting pixel value, and writes the decoded pixel value into the external DRAM 111.

The decoded pixel value stored in the external DRAM 111 is outputted from the output unit 112 in synchronization with a connected device, such as being outputted to a TV, and the like.

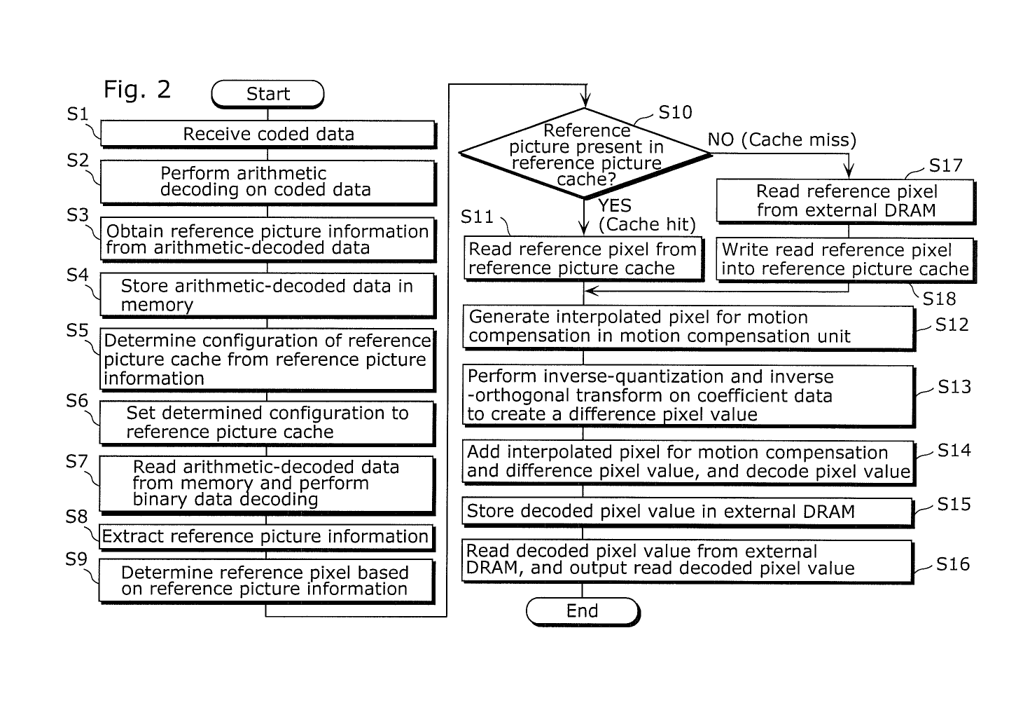

FIG. 2 is a flowchart showing the flow of operations (S1 to S18) performed by the above-described decoding apparatus (picture decoding apparatus).

As shown in FIG. 2, in S1, the input unit 101 receives input of coded data to the picture decoding apparatus. In S2, the arithmetic decoding unit 102 performs arithmetic decoding on the inputted coded data. In S3, the reference picture information obtainment unit 103 obtains reference picture information from the arithmetic-decoded data. In S4, the arithmetic-decoded data is stored in the memory 105.

Subsequently, in S5, the reference picture cache configuration determination unit 104 determines the configuration for the reference picture cache, based on the reference picture information obtained in S3. In S6, the determined configuration is set to the reference picture cache 110.

In S7, the binary data decoding unit 106 reads, from the memory 105, the arithmetic-decoded data stored in the memory 105, and performs binary data decoding on the read arithmetic-decoded data. In S8, reference picture information is extracted. In S9, a reference pixel is specified based on the reference picture information extracted in S8.

In S10, it is judged whether or not the specified reference pixel (copy) is present in the reference picture cache 110. In S11, when it is judged in S10 that the specified reference pixel is present (S10: YES), the reference pixel (copy) is read from the reference picture cache 110. In S17, when it is judged in S10 that the specified reference pixel is not present (S10: NO), the reference pixel is read from the external DRAM 111. In S18, the reference pixel read in S17 is written into the reference picture cache 110.

In S12, the motion compensation unit 109 creates an interpolated pixel for motion compensation, from the read reference pixel. In S13, the pixel value decoding unit 108 performs inverse quantization and inverse orthogonal transform on the coefficient data to create a difference pixel value. In S14, the pixel value decoding unit 108 adds the interpolated pixel for motion compensation and the difference pixel value created in S13, and decodes the resulting pixel value. In S15, the pixel value obtained in the decoding in S14 is stored in the external DRAM 111. In S16, the decoded pixel value is read from the external DRAM 111, and the read pixel value is outputted by the picture decoding apparatus.

Next, details of the method of determining the configuration for the reference picture cache based on the reference picture information, performed by the reference picture cache configuration determination unit 104, shall be described.

In a first method of determining the configuration for the reference picture cache, the number of the reference pictures required in decoding a picture is obtained from the reference picture information. Then, the obtained number of reference pictures is set as the number of ways for the cache (see previous description). The first method is a method according to such a scheme. It should be noted that, in this case, the reference picture cache is a set-associative cache.

Likewise, in a second method of determining the configuration for the reference picture cache, the number of reference pictures required in decoding a picture is also obtained from the reference picture information. Then, as many separate caches are created as the obtained number of reference pictures. The second method is a method according to such a scheme.

For example, when the number of reference pictures is “4”, the storage region of the reference picture cache is divided into 4, each resulting sub-region being created as one direct-mapped cache. Specifically, for example, the storage region is divided into four sub-regions (four parts) in which each of the sub-regions is one direct-mapped cache. Subsequently, for each reference pixel, the cache (sub-region) to be accessed is specified, and the data of the reference picture to be stored in the cache also uses the specified cache (sub-region).

Likewise, in a third method of determining the configuration for the reference picture cache, the number of reference pictures required in decoding a picture is also obtained from the reference picture information. Then, as many caches are created as the number of reference pictures. Furthermore, at the same time, the number of references to each reference picture is obtained, and (the size of) the respective number of references determines the number of entries for the cache of the reference picture for which such number of references was obtained.

For example, take into consideration the case where the reference pictures are reference picture A and reference picture B, and the ratio between the number of references to the reference picture A and the reference picture B is, (number of references for reference picture A): (number of references for reference picture B)=3:1. In this case, the storage region of the reference picture cache 110 is divided into two. Then, it is assumed that the two sub-regions obtained from the division are named reference picture cache A and reference picture cache B. At this time, three-fourths of the total number of entries is allotted to the reference picture cache A, and the data of reference picture A is stored. In addition, one-fourth of the total number of entries is allotted to the reference picture cache B, and the data of reference picture B is stored. It should be noted that, in this manner, the sub-region (reference picture cache A) of the reference picture (reference picture A) having a relatively large number of references may be relatively large, and the sub-region of the reference picture having a relatively small number of references may be relatively small. With this, the size of the respective sub-regions is set to a size that corresponds to the number of references at such sub-region.

In a fourth method of determining the configuration for the reference picture cache, the number of the reference pictures required in decoding a picture is also obtained from the reference picture information. At the same time, the variation in the motion vectors of the respective reference pictures is measured. Then, as many caches are created as the number of reference pictures that are obtained. In addition, the respective sizes of the variation in motion vectors for each reference picture determines the number of entries for the cache of the reference picture for which such size of variation was measured. With this, the size of the cache to be created is set to a size that corresponds to the variation, and thus allowing appropriate sizing.

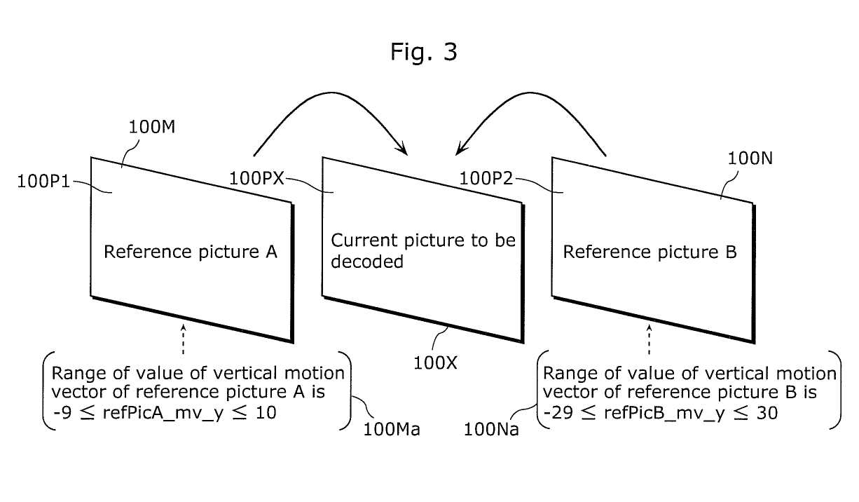

FIG. 3 is a diagram showing the reference picture A, the reference picture B, and a current picture to be decoded.

More specifically, for example, as shown in FIG. 3, it is assumed that two reference pictures are required in decoding a picture, and that the two reference pictures are the reference picture A and the reference picture B.

In addition, it is assumed that the range of the value of the vertical motion vector refPicA_mv_y of the reference picture A is −9≦refPicA_mv_y≦10, and the range of the value of the vertical motion vector refPicB_mv_y of the reference picture B is −29≦refPicB_mv_y≦30. At this time, the storage region of the reference picture cache is divided into two. Then, it is assumed that the two sub-regions are named reference picture cache A and reference picture cache B. At this time, since the size of the above-described refPicA_mv_y value range (−9≦refPicA_mv_y≦10) is 20 (={10−(−9)}+1), and the size of the refPicB_mv_y value range (−29≦refPicB_mv_y≦30) is 60 (={30−(−29)}+1), the subsequent operation is performed. Specifically, in such operation, one-fourth of the total number of entries is allotted to the reference picture cache A, and the data of reference picture A is stored. In addition, three-fourths of the total number of entries is allotted to the reference picture cache B, and the data of reference picture B is stored.

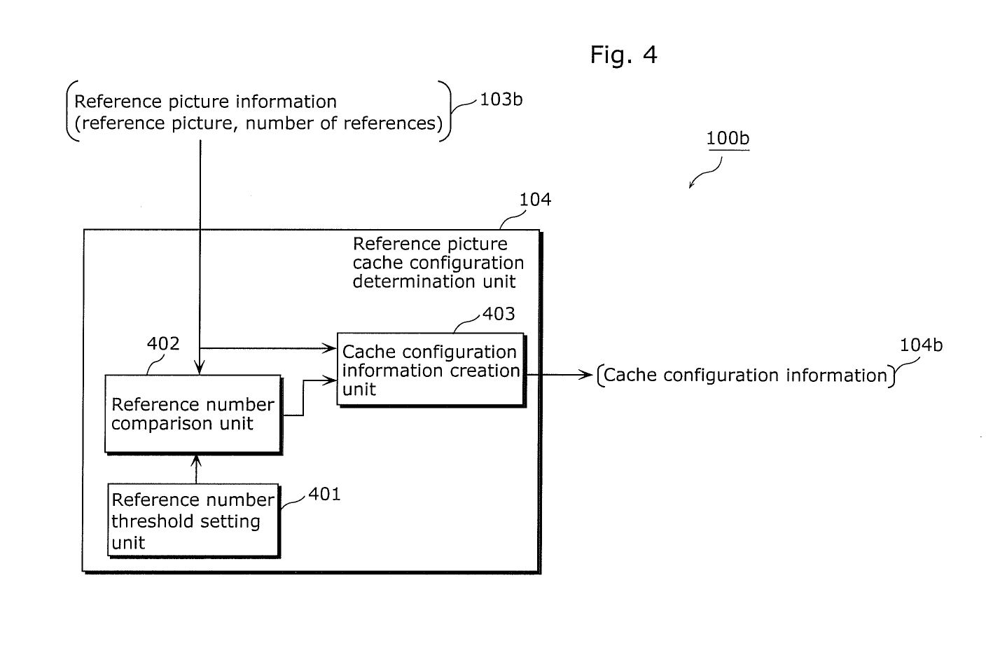

FIG. 4 is a diagram showing the reference picture cache configuration determination unit 104.

A fifth method of determining the configuration for the reference picture cache shall be described using the reference picture cache configuration determination unit 104 shown in FIG. 4.

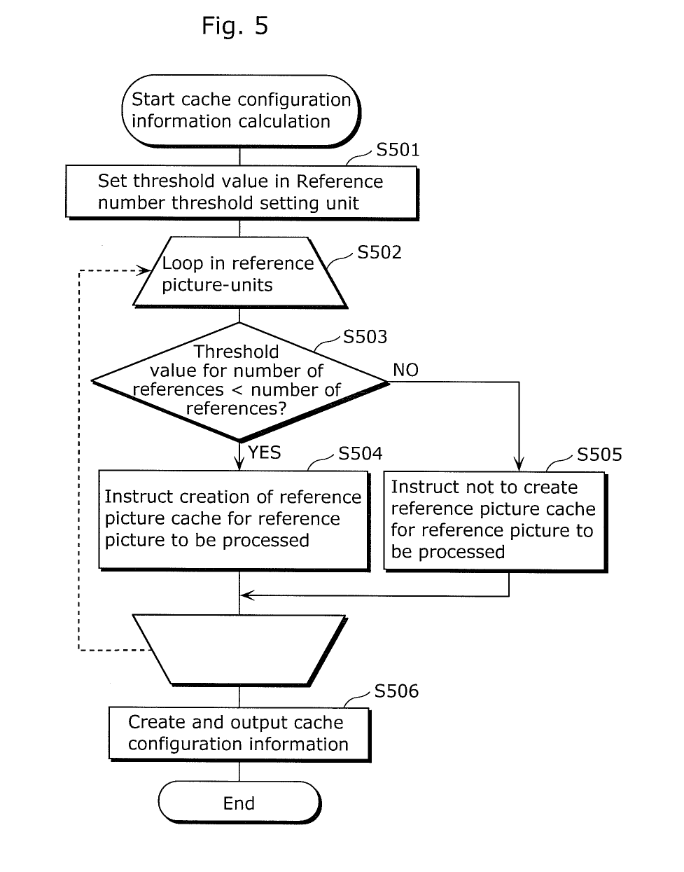

The reference picture cache configuration determination unit 104 shown in FIG. 4 includes a reference number threshold setting unit 401, a reference number comparison unit 402, and a cache configuration information creation unit 403. In addition, reference picture cache configuration determination unit 104 has reference picture information as input, and outputs cache configuration information. The operation of the reference picture cache configuration determination unit 104 shall be described using the flowchart in FIG. 5.

FIG. 5 is a flowchart showing the flow of operations performed by the reference picture cache configuration determination unit 104, in the fifth method of determining the configuration for the reference picture cache.

After the start of the process, first, the threshold value of the reference number threshold setting unit 401 is set (S501). Next, a loop process in reference picture-units (S502) is performed for each reference picture. At this time, when there is no reference picture, the loop process in reference picture-units is not performed, and the operation moves to the next process.

In the loop process in reference picture-units, the reference number comparison unit 402 compares the threshold value for number of references that is set by the reference number threshold setting unit 401 and the number of references to the reference picture (S503). Then, when the number of references is larger (S503: YES), the reference number comparison unit 402 instructs the cache configuration information creation unit 403 to create a reference picture cache for the reference picture subjected to the loop process (S504). On the other hand, when the number of references is smaller than the reference number threshold value (S503: NO), the reference number comparison unit 402 instructs the cache configuration information creation unit 403 not to create a reference picture cache for the reference picture subjected to the loop process (S505).

After the above-described loop process is respectively performed on all of the reference pictures, the cache configuration information creation unit 403 creates cache configuration information based on the information received from the reference number comparison unit 402 and the reference picture information, and outputs the created cache configuration information (S506).

In this manner, for example, the following process may be performed in the picture decoding apparatus.

Specifically, the motion compensation unit 109 uses the one or more reference pictures that are required in the decoding of a picture. In addition, the number (number of pieces) of reference pictures included in the one or more reference pictures to be used is indicated in the reference picture information. It should be noted that, specifically, in generating a compensation signal, the motion compensation unit 109 may perform a process which uses the one or more reference.

The external DRAM 111 stores the one or more reference pictures to be used by the motion compensation unit 109.

The cache unit (reference picture cache 110) stores a copy of at least part of the one or more reference pictures to be used. Subsequently, when the at least part of the one or more reference pictures is to be used by the motion compensation unit 109, the copy stored by the cache unit is used by the motion compensation unit 109.

The reference picture information obtainment unit 103 obtains the above-described reference picture information which indicates the number of the reference pictures to be used.

The reference picture cache configuration determination unit 104 specifies, from among plural configurations, the configuration corresponding to the number indicated in the obtained reference picture information.

Specifically, when the reference picture information indicates a first number, the reference picture cache configuration determination unit 104 specifies a first configuration (for example, a configuration having a number of ways that is equal to the first number).

Here, the specified first configuration is a configuration that is appropriate for the recording of the copies of the one or more reference pictures when the number of the one or more reference pictures to be used is the first number. On the other hand, when the reference picture information indicates a second number for which the first configuration is inappropriate, the reference picture cache configuration determination unit 104 specifies a second configuration (a configuration having a number of ways that is equal to the second number) which is suitable for the second number.

Then, when the above-described one or more reference pictures are to be used by the motion compensation unit 109, the reference picture cache configuration determination unit 104 causes the cache unit to perform storage according to the specified configuration.

It should be noted that, for example, the reference picture cache configuration determination unit 104 may, by generating cache configuration information indicating the specified configuration (number of ways, and so on), cause storage according to the configuration indicated in the generated cache configuration information, that is, cause storage according to the specified configuration.

With this, the first configuration is used only when the number of the reference pictures included in the one or more reference pictures to be used is the first number, and, when the second number is indicated, the configuration to be used is changed such that the second configuration is used. This ensures that the appropriate configuration can be used. Furthermore, since the second configuration, not the first configuration, is used when the second number is indicated, the number of cache misses is reduced, that is, cache misses are lessened. In addition, accesses to the external DRAM 111 which arise due to cache misses are reduced, and thus accesses to the external DRAM 111 can be reduced.

It should be noted that when a number larger than a predetermined standard number (for example, four) is indicated, as the number of reference pictures in the reference picture information, the following operation is performed. Specifically, regardless of the number that is indicated, storage according to the same configuration (for example, a configuration having a number of ways of 4) may be performed. By doing so, configuration is facilitated because storage according to a number of ways of 5 or more is not performed.

It should be noted that, specifically, for example, the reference picture cache configuration determination unit 104 may detect the ending of the next period. Specifically, this period is a period in which a copy of other data aside from the copy of the one or more reference pictures to be used is stored by the reference picture cache 110, and the stored other data is used by the motion compensation unit 109. More specifically, the end of above-described period, and the start of a period in which the copy of the one or more reference pictures is stored and such copy is used, may be detected. Then, the reference picture cache configuration determination unit 104 may store the generated cache configuration information described earlier, in the time up to such detection. In addition, the reference picture cache configuration determination unit 104 may, up to such detection, cause storage according to another configuration aside from the configuration in the stored cache configuration information, and cause storage according to the configuration in the stored cache configuration information after such detection.

It should be noted that the storage region of the cache unit (reference picture cache 110) may be divided into one or more parts (subdivisions). For example, the reference picture cache configuration determination unit 104 may divide the storage region into one or more parts that are the same in number as the number of reference pictures indicated in the reference picture information. Here, each of the parts obtained from the division is a part in which one reference picture corresponding to that part is stored.

Specifically, for example, each of the parts may be a region in which data corresponding to such part, out of N-pieces of data of way 1 data to way N data, is stored. In other words, the cache unit may be a set-associative cache. At this time, the respective configurations to be set may be a configuration in which the aforementioned N in such configuration, that is, the number of ways in such configuration, is different from the number of ways in any of the other configurations.

Furthermore, for example, each of the parts may be one direct-mapped cache.

Specifically, for example, the reference picture cache configuration determination unit 104 may divide the storage region of the cache unit (reference picture cache 110) into one or more parts (sub-regions). In other words, each of the parts may be one direct-mapped cache, and, in each of the parts, one reference picture corresponding to that part may be stored. Here, the number of parts in the one or more parts obtained by dividing the storage region is a number that is the same as the number indicated in the reference picture information. Specifically, the reference picture cache configuration determination unit 104 may create caches according to this division. In other words, for each reference picture, a cache (the cache of such reference picture) configured of the sub-region corresponding to such reference picture and in which such reference picture is stored may be created.

It should be noted that the reference picture information obtainment unit 103 may obtain reference picture information (for example, refIdx and my defined in H.264/AVC) from the arithmetic-decoded data prior to the binary data decoding by the binary data decoding unit 106. In addition, the number that is calculated based on the obtained reference picture information may be specified as the number of the reference pictures included in the one or more reference pictures to be used.

It should be noted that the cache unit may perform the following operation. Specifically, for example, the operation is performed when a part to be used by the motion compensation unit 109, out of the one or more reference pictures stored in the external DRAM 111, is read from the external DRAM 111 by the motion compensation unit 109, and so on. In addition, for example, in such operation, the read part is obtained and, after such reading, a copy including the obtained part may be stored as the above-described copy.

It should be noted that the following picture decoding apparatus may be constructed.

This picture decoding apparatus performs the decoding when picture coding in which a difference value between two pictures is coded using motion vectors is performed. In addition, the memory bandwidth to an external DRAM is narrow, and memory cost and electrical power can be significantly reduced.

In other words, in this picture decoding apparatus, variable-length decoding is performed on a coded stream, and reference pixel data is read from an external DRAM, based on reference picture information and motion vector information which are obtained as a result of such variable-length decoding. Then, motion compensation is performed using the read reference pixel data, and a pixel value is decoded. In addition, the reference pixel data read from the external DRAM is stored in the reference picture cache. Then, the reference picture cache is accessed at the time when the next reference pixel data is read. Subsequently, when the reference pixel data to be read is present in the reference picture cache, such reference pixel data that is present is read from the reference picture cache, and the read reference pixel data is used. When the reference pixel data is not present in the reference picture cache, the external DRAM is accessed. By doing so, access to the external DRAM is reduced.

However, if the cache configuration was fixed, cache misses will occur frequently and access to the external DRAM will increase depending on the stream to be decoded.

In view of this, in this picture decoding apparatus, for example, a reference picture number specification unit specifies the number of reference pictures (and the motion vector value) in the arithmetic decoding unit. Then, having the obtained number of reference pictures (and motion vector value) as input, the reference picture cache configuration determination unit determines the configuration for the reference picture cache.

Next, during the decoding of the pixel value by the pixel value decoding unit, the reference picture cache is constructed according to the configuration determined by the reference picture cache configuration determination unit. Subsequently, the reference pixel data used in motion compensation is stored in the constructed reference picture cache having the determined configuration. Then, when reference picture data is to be obtained, the pixel value decoding unit first accesses the reference picture cache. Then, in the case of a cache hit, the value read from the reference picture cache is used in the motion compensation, and, in the case of a cache miss, the external DRAM is accessed and reference pixel data is obtained.

With the above-described method, the configuration of the reference picture cache is determined at the time of arithmetic decoding. With this, it is possible to construct a reference picture cache that is appropriate for the stream to be coded, and, compared to when a reference picture cache having a fixed cache configuration is used, cache misses can be further reduced and the required cache capacity can be reduced. Furthermore, with this, it is possible to prevent multiple reading of the same reference pixel from the external DRAM, and thus reduce the amount of accesses to the external memory. In addition, memory band width reduction, increased coding process speed, and circuit size reduction become possible.

It should be noted that, when the number of reference pictures is 1, the reference picture cache may be configured with the direct mapping scheme (number of ways=1) as the scheme to be used.

In addition, when the number of reference pictures is 2, the reference picture cache may be configured with the set-associative scheme having a number of ways=2 as the scheme to be used.

In addition, when the number of reference pictures is several pictures (≧5), 2 to 4 pictures having a large number of references may be selected, and the reference picture cache may be configured with the set-associative scheme.

When the number of reference pictures is 2, and the motion vector variation for one of the reference pictures is large and the variation for the other reference picture is small, more of the cache region may be allotted to the reference picture having the large variation.

Thus, for example, in a particular situation, the subsequent operation may be performed.

Specifically, the decoding apparatus 100 (see FIG. 10) may decode coded data 21b (see 102a in FIG. 1) obtained through a coding process including at least arithmetic coding, into decoded data 26c.

The input unit 21 may obtain the coded data 21b.

It should be noted that the input unit 21 may be, for example, the input unit 101 in FIG. 1, and may be at least a part of the input unit 101.

It should be noted that, hereinafter, detailed description of correspondence relationships between such elements (input unit 21, and so on) shown in FIG. 10 and elements in FIG. 1 (input unit 101) shall be shall be omitted as deemed appropriate for the sake of convenience in description.

A Context-based Adaptive Binary Arithmetic Coding (CABAC) processing unit (first decoding unit) 22 may perform arithmetic-decoding on the obtained coded data 21b, and generate the coding condition 23a (103b), which is used in the coded data 21b, and arithmetic-decoded data 24d (102b).

A first storage medium 24 may be a storage medium having a first capacity, and capable of reading, at a first speed, information to be stored. In addition, the first storage medium 24 may store the coding condition 23a and the arithmetic-decoded data 24d.

Specifically, the first storage medium 24 may be, for example, a Dynamic Random Access Memory) DRAM provided to the decoding apparatus 100. In addition, the first storage medium 24 may, for example, be provided outside of an integrated circuit 100L which is provided to the decoding apparatus 100 and includes the above-described CABAC processing unit 22.

A second storage medium 25 may be a storage medium having a second capacity which is smaller than the first capacity, and capable of reading information to be stored, at a second speed which is faster than the first speed.

In addition, the second storage medium 25 may store cache data 25d (110d) which is (data obtained by copying) partial picture data 24eP of already-decoded picture data 24e to be stored in the first storage medium 24.

In other words, the second storage medium 25 may be, for example, a cache which stores the cache data 25d which is a copy of the partial picture data 24eP (111d) described above.

A decoder (second decoding unit) 26 may perform decoding on the above-described arithmetic-decoded data 24d, based on the decoded picture data 24e stored in the first storage medium 24 or the cache data 25d (see data 25b) stored in the second storage medium 25.

Specifically, for example, both the decoder 26 and the second storage unit 25 which stores the cache data 25d used by the decoder 26 may be provided to the above-described semiconductor circuit 100L.

The setting unit (storage method setting unit) 23 may perform the subsequent operation, prior to the decoding process by the decoder 26.

Specifically, such operation is an operation for setting the method for storing the cache data 25d in the second storage medium 25, based on the coding condition 23a generated from coded data 2d (for example, (one or both of) the arithmetic-decoded data 24d (and the coded data 21b prior to the arithmetic decoding)) to be decoded by the decoder 26.

Specifically, information of the above-described coding condition 23a may be generated and the coding condition 23a may be specified, for example, when the arithmetic decoding (arithmetic decoding process) is to be performed.

It should be noted that, this specifying, for example, may be performed by the setting unit 23, or may be performed by another element.

Accordingly, the cache data 25d is stored, and the coded data 21b is decoded to the decoded data 26c through a process using the stored cache data 25d (see aforementioned Patent References 1, 2, and so on).

It should be noted that the decoding apparatus 100 may be, for example, at least a part of a Blu-ray recorder which decodes the coded data 21b recorded on a Blu-ray disc. Furthermore, for example, the decoding apparatus 100 may be a television, a camera, or a cellular phone which performs a process of decoding, and so on.

However, at least a part of the picture data 24e including the partial picture data 24eP, which is copied to the cache data 25d, are reference pictures (see reference pictures 100M, 100N, and so on, in FIG. 3) to be referred to in the decoding performed with the cache data 25d being stored.

In other words, the data amount of the picture data 24e is a relatively large data amount.

As such, there is a possibility that, when the cache data 25d is stored, a cache miss will occur, and the transfer amount of data, such as the transfer amount in the transfer of data between the cache 25 and the first storage medium 24, for example, becomes a large transfer amount.

Furthermore, by extension, there is the possibility that, since a transfer of a large transfer amount is performed, a large amount of power is consumed by the transfer process, and thus power consumption increases.

In view of this, attention is focused on the storage method in the storing of the cache data 25d.

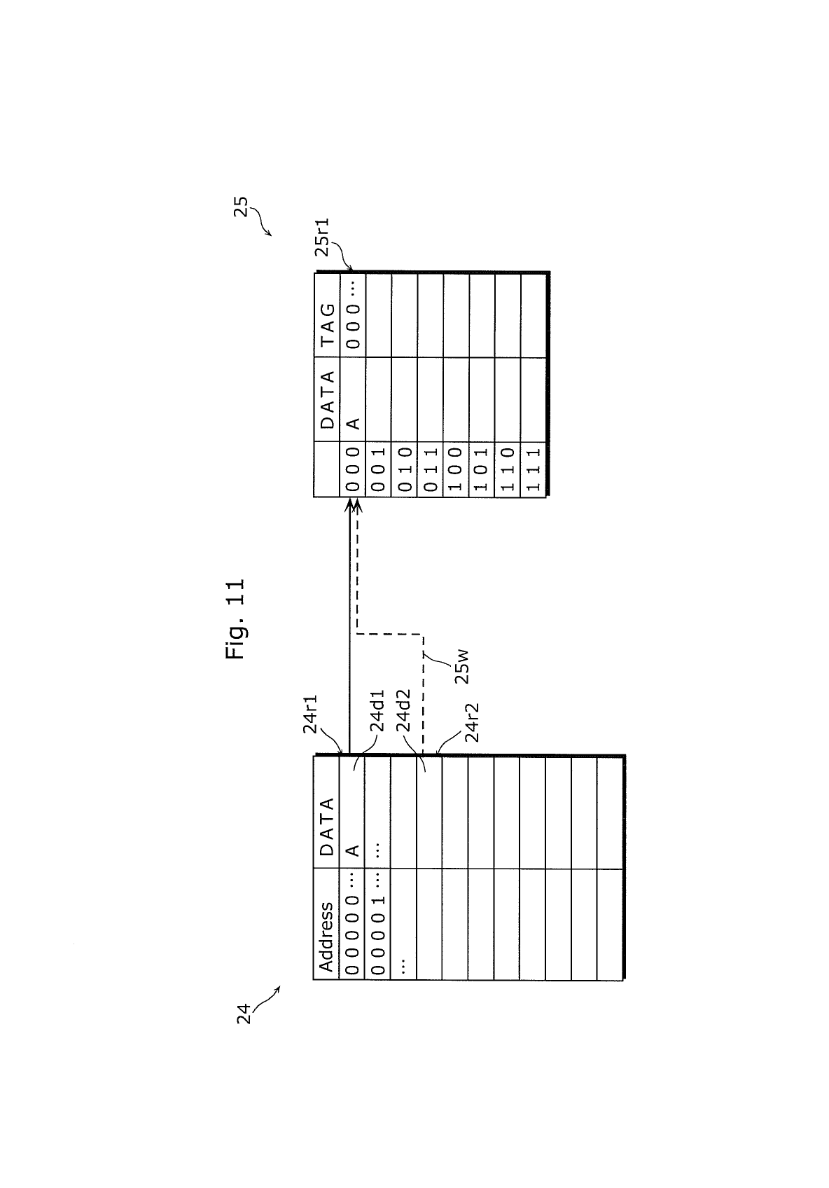

Specifically, as storage methods, along with the relatively inappropriate first storage method (for example, the storage method in FIG. 11 described later), there is also a relatively appropriate second storage method.

Specifically, the relatively inappropriate first storage method is a storage method, and so on, in which relatively many cache misses occur and power consumption increases when storage is performed according to such storage method.

In addition, the appropriate second storage method is a storage method, and so on, in which (many) cache misses do not occur and power consumption is low.

In view of this, information (coding condition 23a) specifying each of the first storage method and the second storage method may be generated.

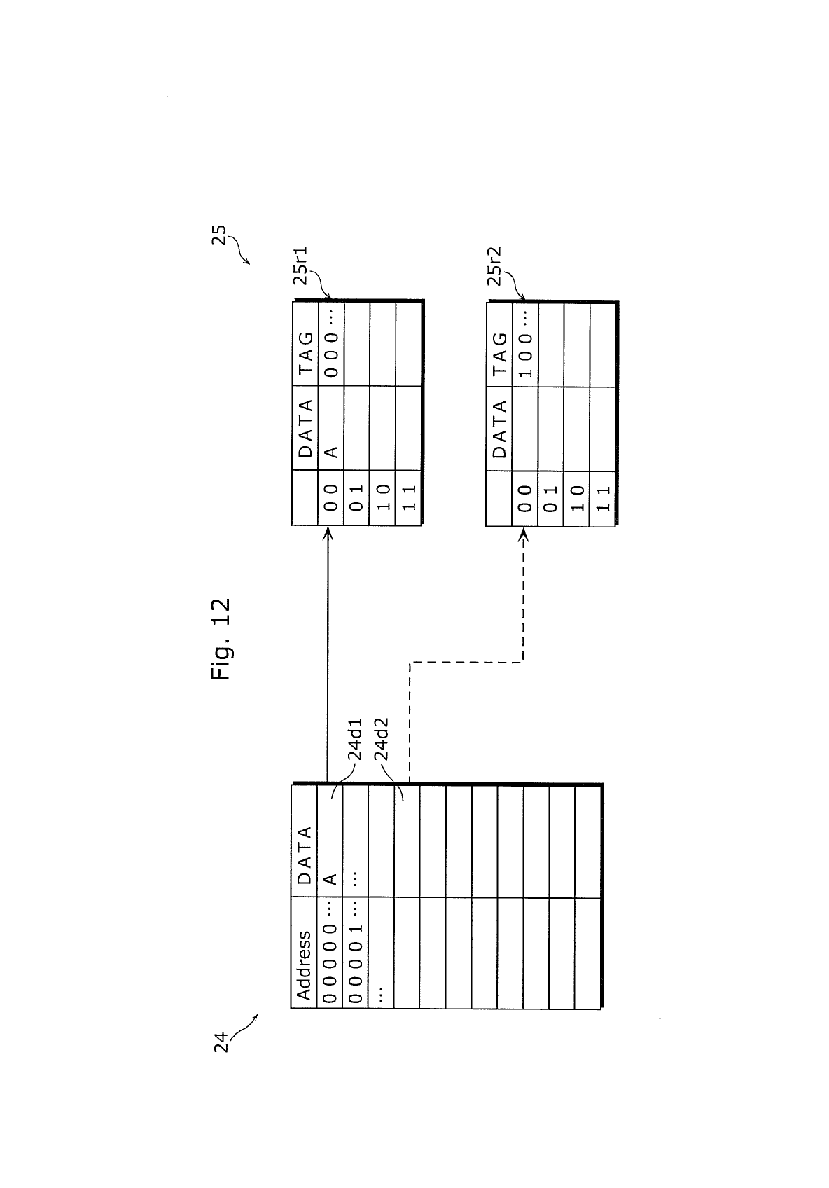

In addition, storage may be performed according to the appropriate second storage method (FIG. 12) that is specified, without performing storage according to the inappropriate first storage method (FIG. 11) specified in the generated information.

With this, power consumption can be further reduced.

However, it is desirable that the process for decoding the coded data 21b to the decoded data 26c in the decoding apparatus 100 be a simpler process.

Meanwhile, in recent years, there are instances where decoding according to the H.264 high profile standard is performed.

Specifically, for example, the decoding from the coded data 21b to the decoded data 26c performed by the decoding apparatus 100 may be decoding in the H.264 high profile.

More specifically, in the decoding from the coded data 21b to the decoded data 26c, after processing in a first pass (see first stage processing, CABAC processing unit 22 in FIG. 10) is performed, processing in a second pass (see second stage processing, decoder 26) may be performed.

However, for example, the data used in the processing in the second pass includes the above-described reference pictures and is extremely large data.

In view of this, the cache data 25d to be stored according to the storage method (the appropriate second storage method) which is based on the generated information (coding condition 23a) need only be used in the processing in the second pass (processing by the decoder 26), and need not be used in the processing in the first pass (processing by the CABAC processing unit 22).

In addition, the above-described information (coding condition 23a) may be specified in the processing in the first pass (processing by the CABAC processing unit 22).

Then, after the processing in the first pass (CABAC processing unit 22) ends, the following may be performed in the processing in the second pass (decoder 26).

Specifically, in the processing in the second pass, the cache data 25d may be stored according to the appropriate second method (FIG. 12), without being stored according to the inappropriate first method (FIG. 11) indicated in the specified information.

With this, the number of times of passes (number of processing stages) is prevented from increasing and is maintained at a small number of times (number of stages), and thus the number of stages can be reduced.

This allows the process to be further simplified.

In this manner, minimal number of stages can be achieved together with minimal power consumption.

It should be noted that since the process is simple as described above, the configuration can be made relatively simple.

Furthermore, since the process is simple, power consumption is further reduced, and thus power consumption can be reduced relatively significantly.

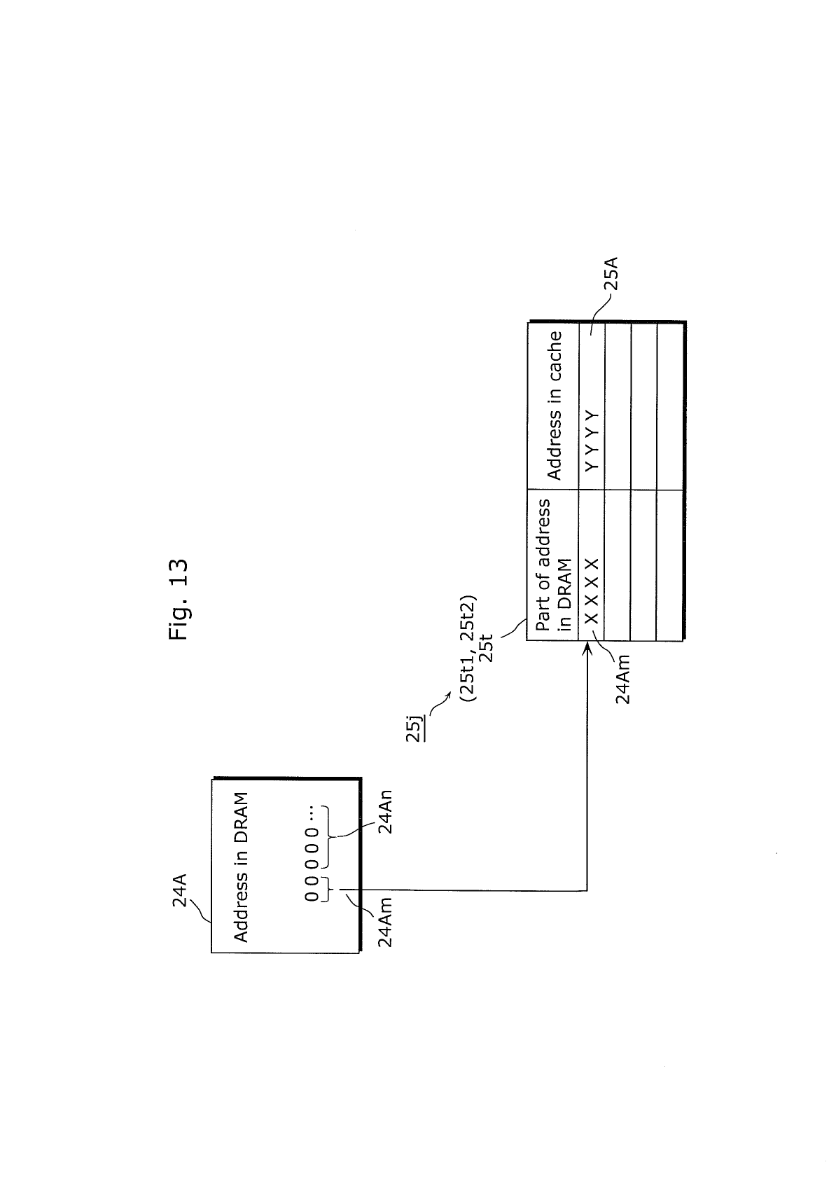

Subsequently, for example, the setting unit 23 may set, based on the above-described coding condition 23a, the correspondence relationship (see correspondence relationship data 25t) between part of the information (a part 24Am of the address 24A) of the address information of the cache data 25d in the first storage medium 24 (see address 24A in the first storage medium 24 shown in FIG. 13), and the address information when the cache data 25d is to be stored in the second storage medium 25 (address 25A in the second storage medium 25).

Specifically, for example, for the part 24Am of the address 24A in the first storage medium 24 in which data which is at least a part of the above-described partial picture data 24eP is stored, the address 25A in the second storage medium 25 is associated thereto according to the set correspondence relationship.

In addition, data (at least part of the cache data 25d) which is a copy of the aforementioned data to be stored may be stored in the address 25A, which is associated with the part 24Am of the data stored in address 24A, in the second storage medium 25.

Subsequently, when an inappropriate first correspondence relationship (for example, the correspondence relationship of first data 25t1) is set, storage according to the above-described inappropriate first storage method (see previous description) may be performed.

Subsequently, when an appropriate second correspondence relationship (the correspondence relationship with second data 25t2) is set, storage according to the appropriate second storage method may be performed.

Then, the inappropriate first correspondence relationship (first data 25t1) and the appropriate second correspondence relationship (second data 25t2) may be specified by the above-described information (coding condition 23a).

In addition, control may be performed such that the inappropriate first correspondence relationship specified by the information is not set and storage according to the first storage method is not permitted.

In addition, control may be performed so as to set the appropriate second correspondence relationship that is specified and cause storage according to the second storage method.

With this, it is sufficient to merely set the above-described correspondence relationships, and thus the processing to be performed is further simplified.

It should be noted that, for example, it is acceptable to provide a storage control unit (FIG. 13) which performs control for causing the storage to the address 25A of the second storage medium 25, which is associated in the set correspondence relationship described above.

The storage control unit 25j may, for example, be a part of the setting unit 23 (FIG. 10), and may be a part of the cache 25.

It should be noted that, for example, the setting of the correspondence relationships may mean storing the data 25t specifying such correspondence relationships, for example, in a predetermined region such as a storage region provided in the storage control unit 25j, and performing control according to the correspondence relationships in the stored data 25t.

Furthermore, when the there are plural reference pictures (reference pictures 100M, 100N, and so on, in FIG. 3) to be used by the decoder 26, the setting unit 23 may logically divide (the region of) the above-described second capacity in the second storage medium 25 (to the appropriate two or more sub-regions, such as sub-regions of a number equivalent to the number of pictures) in accordance with the number of reference pictures.

It should be noted that, for example, the number of pictures of the decoded picture data 24e (FIG. 10) described above may be 1 picture or plural pictures. In addition, each of the 1 or plural reference pictures (reference picture 100M and so on) described above may be the picture of 1 picture data out of the 1 or plural pieces of picture data 24e.

Moreover, the number of reference pictures may be specified by the previously described information (coding condition 23a).

In addition, division into as many sub-regions as the number of pictures specified by the information may be performed.

Accordingly, when the number of reference pictures to be referenced is 1, division into two or more sub-regions is not performed, and storage of the reference picture can be performed in the wide region prior to division.

In addition, in the case of plural pictures, division into two or more sub-regions is performed, and one of the reference pictures is stored in one of the sub-regions, after which another of the reference pictures is stored in another different sub-region. With this, the occurrence of a cache miss due to storage of data in the same sub-region and rewriting of the stored data (see rewriting 25w shown in FIG. 11 described later) is avoided, and thus power consumption can be further reduced.

Please also refer to the earlier description regarding the process of dividing the storage region.

Furthermore, for example, based on information regarding data (for example, second data 24d2 in FIG. 11 described later) to be used by the decoder 26, out of the decoded picture data 24e (FIG. 10), obtained from the coding condition 23a, the setting unit 23 may set the storage method such that the rewriting (see rewriting 25w) of the cache data 25d to be stored in the second storage medium 25 is [symbol] further reduced in the decoding process by the decoder 26.

Specifically, this process may have any format among plural appropriate formats.

For example, in a certain format, the subsequent operation may be performed.

Specifically, the rewriting (rewriting 25w in FIG. 11) in the second storage medium 25 occurs, for example, in the following case.

This is the case when first data (first data 24d1 in FIG. 11) to be used by the decoder 26 is allocated, according to the coding condition 23a, so as to be stored in the address 000 (storage region 25r1) of the second storage medium 25, and on the other hand, second data (second data 24d2 in FIG. 11) is also allocated, according to the coding condition 23a, so as to be stored in the address 000 (storage region 25r1).

When storage of the second data in the second storage medium 25 is attempted when the first data is already stored in the address 000 of the second storage medium 25, rewriting of the second storage medium 25 occurs.

Subsequently, the setting unit 23 may perform the subsequent operation based on the coding condition 23a which is the previously described information.

Specifically, in this operation, it is not necessary to cause the performance of storage according to the first storage method (storage method in FIG. 11) in which the region in the second storage medium 25 into which the second data 24d2 (described above) is to be stored and which is specified from the coding condition 23a is the same as the aforementioned first region 25r1.

In addition, the operation, for example, may cause storage according to the second storage method (storage method in FIG. 12) in which the region in the second storage medium 25 into which the second data 24d2 is stored is the second region 25r2.

It should be noted that with respect to the 3 digits for “000”, and so on, in the first column in the diagram of the second storage medium 25 in FIG. 11, FIG. 12 has 2 digits as in “00” and so on.

With this, it is possible to avoid a cache miss occurring when the second data (second data 24d2) is written into the same region and the first data (data 24d1) is to be used after such writing.

With this, the occurrence of (relatively many) cache misses is avoided, and thus power consumption can be reduced.

Furthermore, for example, the coding condition 23a may include a motion vector (illustration omitted).

In addition, this motion vector may specify, as the data to be used by the decoder 26, data (for example, the above-described second data 24d2) at a position obtained after the motion indicated by this motion vector occurs.

Then, the setting unit 23 need not cause the storage according to the first storage method (storage method in FIG. 11) which is inappropriate when the data (second data 24r2) at the position (described above) of the motion vector included in the generated information (coding condition 23a) described above.

In other words, the setting unit 23 may cause the storage according to the second storage method (storage method in FIG. 12) which is appropriate when the data (second data 24r2) at the position of the included motion vector is to be used.

It should be noted that it is possible to have the following first case and second case.

Specifically, it is possible that at least part of the reference pictures (one out of one or more reference pictures) in the decoding which uses the second data 24d2 is the same as a reference picture in the decoding of the first data 24d1 in the first case, while being different in the second case.

As such, it is considered that only in the first case does a cache miss occur in the case where the region (an other region) of the second data is the same as the first region 25r1 (one region) of the first data, and that a cache miss does not occur in the second case even in the case where the regions are the same.

Therefore, for example, the above-described operation may be performed only in the first case, and need not be performed in the second case.

With this, it is possible to avoid the performance of the above-described operation regardless of whether a cache miss does not occur or a cache miss cannot be avoided (that is, despite it being the second case), and thus unnecessary operation is not carried out and power consumption is further sufficiently reduced.

It should be noted that, in this manner, the second storage medium 25 may have one region in which the first data 24d1 is stored and another region in which the second data 24d2 is stored, and the other region may either be the same region as the one region or a different region.

In addition, in the above-described first case in which a cache miss occurs, for example, the subject, and so on (for example, a car) appearing in the image of the first data 24d1 may be the same as the subject, and so on, in the image of the second data 24d2 in at least some cases.

In addition, it is possible to have, in a first reference picture (for example, the reference picture 100M in FIG. 3) in which a first image of the first data 24d1 is included, a first position 100P1 (see FIG. 3) of the first image.

Furthermore, it is also possible to have, in a second reference picture (for example, the reference picture 100N in FIG. 3), a second position 100P2 of a second image of the second data 24d2.

In addition, for example, the aforementioned subject, and so on, may be a still object, and so on.

In view of this, for example, the second position 100P2 may be the same position as (or a neighboring position to) the first position 100P1, and so on.

It should be noted that, specifically, the second position 100P2 may be a position resulting from the movement indicated by the aforementioned motion vector.

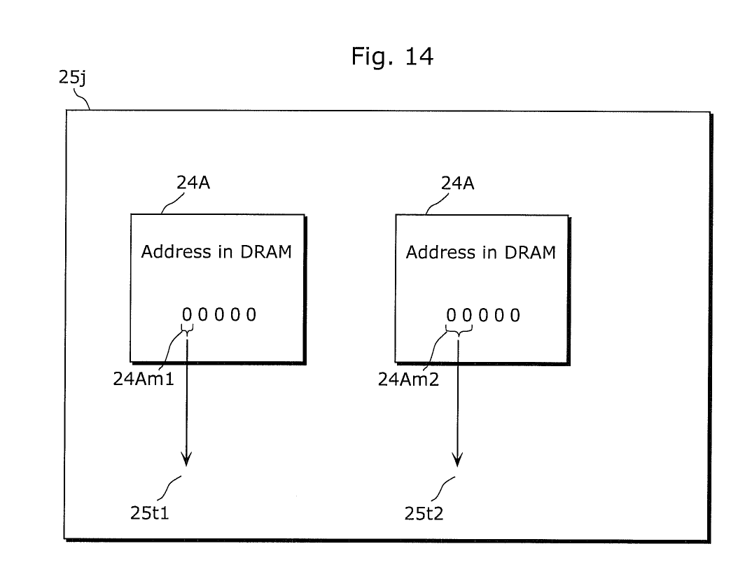

It should be noted that FIG. 14 shows two addresses 24A (the two consisting of the left-side and right-side) in the first storage medium 24, a part 24Am1 of the left-side address 24A, and a part 24Am2 of the right-side address 24A. Please refer to FIG. 14 as necessary.

It should be noted that the first storage medium 24 may, for example, store only the coded data 24d out of the coding condition 23a and the coded data 24d.

It should be noted that, for example, a current picture to be decoded 100× that is to be decoded using the first data 24d1 (FIG. 3) may be the same as the current picture to be decoded 100× that is to be coded using the second data 24d2 in the first case, and different in the second case. In addition, control for making the region in which the first data 24d1 is to be stored different from the region in which the second data 24d2 is to be stored need only be performed in the first case. With this, unnecessary processing is not performed, and processing can be reduced while maintaining high performance.

It should be noted that it is possible that, for example, when the measured motion vector variation is greater than a threshold value, referencing of more places is performed, and cache misses tend to occur. In view of this, when the variation is greater than the threshold value, the number of entries of the reference pixel data cache may be further increased.

It should be noted that the external DRAM 111 shown in FIG. 1 may specifically be, for example, a part which stores the decoded picture data 24e, out of the first storage medium 14.

In addition, for example, the memory 105 shown in FIG. 1 may be a part which stores the coded data 24d, out of the first storage medium 14 shown in FIG. 10.

It should be noted that at least part of the decoder 26 may be, for example, the pixel value decoding unit 108 in FIG. 1. In addition, for example, the decoder 26 may, together with including the pixel value decoding unit 108, include part or all of the binary data decoding unit 106, the motion compensation unit 109, and the reference picture information extraction unit 107 shown in FIG. 1.

It should be noted that, as shown in FIG. 1, the picture decoding apparatus 100 may include a part 100p which performs the first stage processing (processing in the first pass), and a part 100q which performs the second stage processing (processing in the second stage).

It should be noted that, out of the memory 105, a part such as the part which transmits data to the binary data decoding unit 106 may be included in the part 100q of the second stage.

It should be noted that, as previously described, the first storage method may be a storage method having a different number of ways as the number of ways in the second storage method, and may be a storage method with the same number of ways.

It should be noted that, more specifically, for example, the following are also acceptable.

Specifically, as previously described, in the present decoding apparatus 100, decoding in the H.264 high profile may be performed. Specifically, at least part of the processing in the first pass (first stage processing), as described earlier, is an arithmetic decoding process and not other inappropriate processes.

Here, other inappropriate processes are processes with which the above-described information or relatively appropriate information cannot be generated, and so on.

Here, appropriate information is information whereby when storage is performed according to a storage method based on such information, the number of cache misses is less than the predetermined threshold and is reduced relatively significantly.

With this, for example, the above-described information can be specified, and the above-described operation can be made possible. Furthermore, for example, relatively appropriate information can be specified and the above-described operation can be made into a more appropriate operation, and thus, for example, the number of cache misses can be significantly reduced.

In this manner, with the present technique, elements (CABAC processing unit 22, setting unit 23, and so on) are combined, and a synergistic effect arises from the combination. In contrast, the known prior art lacks part or all of these elements, and thus a synergetic effect does not arise.

Thus, the present technique is different from the prior art in terms of this point.

In short, in this manner, it is possible to solve the problem in that, when decoding a coded stream related to video coded using arithmetic coding and inter-picture prediction, there are cases where the reference picture cache cannot operate effectively and the amount of accesses in obtaining reference pictures from the external memory increases. Specifically, the picture coding apparatus 100 includes: the external DRAM 111 which stores a reference picture, the motion compensation unit 109 which uses the reference picture; the reference picture cache 110 which stores the reference picture; the reference picture information obtainment unit 103 which obtains reference picture information of the reference picture; and the reference picture cache configuration determining unit 104 which generates, based on the reference picture information, cache configuration information used in creating the configuration of the reference picture cache.

It should be noted that, in this manner, there is coded data A on which arithmetic decoding is performed, and coded data B whose cache data is stored according to the set storage method.

The coded data B may be the same coded data as the coded data A.

Furthermore, the coded data B may be different coded data.

With this, even when the coding condition for the coding data B cannot be generated, and so on, the storage of the cache data of the coded data B is performed (relatively) appropriately, and thus appropriate storage can be performed relatively reliably.

Although the present invention is described based on the above embodiment, the present invention is not limited to the above embodiment, and various improvements and modifications are possible within a scope that does not depart from the essence of the present invention. For example, various modifications to the above-described embodiment that can be conceived by a person of ordinary skill in the art or forms constructed by combining components of embodiments described in different places are included in the scope of the present invention.

It should be noted the present invention may be realized as a computer program for implementing part or all of the above-described function in a computer. Furthermore, the present invention can be realized as a storage medium in which such computer program is stored. Furthermore, the present invention may be realized as an integrated circuit which realizes part or all of the above-described functions.

### INDUSTRIAL APPLICABILITY

The present invention is capable of reducing accesses to an external memory in the obtainment of a reference picture, performed when decoding a coded stream related to video coded using arithmetic coding and inter-picture prediction. Furthermore, the present invention is particularly effective when handling data coded according to H.264/AVC.

The present invention can achieve both minimal power consumption and a minimal number of processing stages.

What is claimed is:

1. A decoding apparatus that decodes coded data generated through coding including at least arithmetic coding, said decoding apparatus comprising:
an obtainment unit configured to obtain the coded data;
a first decoding unit configured to perform arithmetic decoding on the obtained coded data to generate (i) a coding condition of the coded data and (ii) arithmetic-decoded data;
a first storage medium for storing the coding condition and the arithmetic-decoded data, said first storage medium having a first capacity and allowing reading of stored information at a first speed;
a second storage medium for storing cache data, said second storage medium having a second capacity which is smaller than the first capacity and allowing reading of stored information at a second speed which is faster than the first speed, and the cache data being picture data that is part of decoded picture data stored in said first storage medium;
a second decoding unit configured to decode the arithmetic-decoded data based on the decoded picture data stored in said first storage medium or the cache data stored in said second storage medium; and
a storage method setting unit configured to set a storage method for storing the cache data in said second storage medium, based on a coding condition obtained during generation of coded data which precedes current coded data to be decoded by said second decoding unit.

2. The decoding apparatus according to claim 1,
wherein said storage method setting unit is configured to set, based on the coding condition, a correspondence relationship between information that is part of address information of the cache data in said first storage medium and address information used in the storing of the cache data in the second storage medium.

3. The decoding apparatus according to claim 1,
wherein, when a plurality of reference pictures are to be used by said second decoding unit, said storage method setting unit is configured to logically divide the second capacity according to the number of the reference pictures.

4. The decoding apparatus according to claim 1,
wherein said storage method setting unit is configured to set the storage method based on information obtained from the coding condition and regarding data to be used by said second decoding unit out of the decoded picture data such that, in the decoding by said second decoding unit, rewriting of the cache data to be stored in said second storage medium is reduced.

5. The decoding apparatus according to claim 1,
wherein rewriting in said second storage medium occurs when a second region, in said second storage medium, in which second data to be used by said second decoding unit is to be stored is the same as a first region, in said second storage medium, in which first data to be used by said second decoding unit is to be stored, the second data being specified by the coding condition, and
said storage method setting unit is configured to, based on the coding condition, (i) prevent storage according to a first storage method in which the second region, in which the second data specified by the coding condition is to be stored, is the same as the first region, and (ii) cause storage according to a second storage method in which the second region is different from the first region.

6. The decoding apparatus according to claim 1,
wherein the coding condition includes a motion vector,
the motion vector specifies, as data to be used by said second decoding unit, data at a position obtained after a motion indicated by said motion vector, and
said storage method setting unit is configured to, based on the coding condition, (i) prevent storage according to a first storage method that is inappropriate when the data of the position of the motion vector included in the coding condition is to be used, and (ii) cause storage according to a second storage method that is appropriate when the data of the position is to be used.

7. The decoding apparatus according to claim 1,
wherein said storage method setting unit is configured to, for each reference picture to be referred to by a picture to be decoded, (i) count the number of references to the reference picture, and (ii) determine, according to the counted number of references, the number of entries for a reference pixel data cache which is for the reference picture having the counted number of references and made up of at least a part of said second storage medium.

8. The decoding apparatus according to claim 1,
wherein said storage method setting unit is configured to, for each reference picture to be referred to by a picture to be decoded, (i) measure a variation of a motion vector, and (ii) determine, according to the measured variation, the number of entries for a reference pixel data cache which is for the reference picture for which the magnitude was measured and made up of at least a part of said second storage medium.

9. The decoding apparatus according to claim 1, comprising
a reference number threshold value setting unit,
wherein said storage method setting unit is configured to, for each reference picture to be referred to by a picture to be decoded, (i) count the number of references to the reference picture, and (ii) when the counted number of references is less than a value set by said reference number threshold value setting unit, prevent (a) creation of a reference pixel data cache which is for the reference picture having the counted number of references and made up of at least a part of said second storage medium, and (b) storage of pixel data of the reference picture in said second storage medium.

10. A decoding method of decoding coded data generated through coding including at least arithmetic coding, said decoding method comprising:
obtaining the coded data;
performing arithmetic decoding on the obtained coded data to generate (i) a coding condition that was used for the coded data and (ii) arithmetic-decoded data;
storing the coding condition and the arithmetic-decoded data performed by a first storage medium which has a first capacity and allows reading of stored information at a first speed;
storing cache data performed by a second storage medium which has a second capacity which is smaller than the first capacity and allows reading of stored information at a second speed which is faster than the first speed, the cache data being picture data that is part of decoded picture data stored in the first storage medium;
decoding the arithmetic-decoded data based on the decoded picture data stored in said storing of the coding condition and the arithmetic-decoded data or the cache data stored in said storing of cache data; and
setting a storage method for the storing of the cache data in said storing of cache data, based on a coding condition obtained during generation of coded data which precedes current coded data to be decoded in said decoding.
